(19) United States
(12) Patent Application Publication
(10) Pub. No.: US 2014/0268474 A1
(43) Pub. Date: Sep. 18, 2014

(54) METHOD OF CLOSING A RELAY SWITCH AND APPARTUS THEREOF

(71) Applicant: LUTRON ELECTRONICS INC., CO., Coopersburg, PA (US)

(72) Inventors: James P. Steiner, Royersford, PA (US); Ryan S. Bedell, West Palm Beach, FL (US)

(73) Assignee: Lutron Electronics Inc., Co., Coopersburg, PA (US)

(21) Appl. No.: 13/800,787

(22) Filed: Mar. 13, 2013

(51) Int. Cl. H01H 47/04; H01H 47/22

(52) U.S. Cl. CPC H01H 47/04; H01H 47/223
USPC 361/195; 361/160

(57) ABSTRACT

A load control device for controlling an amount of power delivered from an alternating current (AC) power source to an electrical load includes a relay operable to be coupled in series electrical connection between the AC power source and the electrical load. The relay has one or more relay contacts. The load control device includes a zero-cross detector operable to detect zero crosses of the alternating current and to generate zero cross signals, and a controller operatively coupled to a control input of the relay and the zero-cross detector for rendering the controllably conductive device conductive and non-conductive. The controller determines a relay actuation adjustment such that the contact reliably completes bouncing just prior to a zero cross and may initiate an actuation of the relay based on the actuation adjustment and the zero cross signal.

### BACKGROUND

Load control devices, such as switches, for example, use electrical relays to switch alternating currents being supplied to an electrical load. The life time of such electrical relays may be shortened by arcs or sparks caused at the instant when the relay closes. Some prior art systems seek to suppress arcs by controlling the relay actuation time such that the relay contacts close as nearly as possible to a zero cross of the AC waveform.

FIG. 1 depicts an AC voltage waveform as controlled by an example prior art relay switch control circuit. Waveform 100 depicts the waveform of the AC power source, where the portion in dashed line may represent the voltage of the AC power source, and the portion in solid line may represent the voltage across an electrical load. As shown, the waveform 100 may cross the neutral or zero line at voltage zero crosses such as the zero crosses 110A and 110B. The example prior art relay switch control circuit may include a voltage zero cross detector for detecting the zero crosses such as the zero cross 110A. The example prior art relay switch control circuit may store a relay-actuation delay 120, which corresponds to the time interval between the relay actuation time and the time when the relay contacts initially close in response to actuation. In operation, the relay switch control circuit may actuate the relay at relay actuation time 130A prior to the next zero cross point 110B. As shown, the relay actuation time 130A leads the next zero cross point 110B, or the target zero cross for relay closure, by the relay-actuation delay 120 such that the relay contacts close at a time corresponding to the target zero cross 110B.

In operation, the example prior art relay switch control circuit detects the zero cross 110A, waits for a relay actuation adjustment 150A, and actuates the relay at time point 130A. The relay actuation adjustment 150A corresponds to the difference between a full AC cycle and the relay-actuation delay 120. When the relay contacts are closed at the zero cross 110B, substantially no current flows through the relay contacts. The value of the relay-actuation delay 120 may be updated to account for any variation caused by temperature, and/or aging or deterioration over the life time of the relay.

When a relay closes, however, there is a settling time before the relay contacts come to rest in the closed state. For example, as shown in FIG. 1, the relay contacts may bounce one or more times for a time period 140 before becoming steadily closed. Bouncing results in wasted energy that may dissipate in the relay contacts as heat. This heat may cause the relay contacts to weld and become inoperative.

Some prior art systems seek to address this problem by offsetting the relay actuation time by one-half of the relay contact-bounce duration. FIG. 2 depicts an AC waveform as controlled by an example prior art relay switch control circuit with bounce compensation. Here, the relay actuation adjustment 150B corresponds to the difference between a full AC line cycle and the sum of relay-actuation delay 120 and one-half of the relay contact-bounce duration 140. In other words, the relay actuation adjustment 150B is less than the relay actuation adjustment 150A by one-half of the relay contact-bounce duration. A relay actuation time 130B leads the target zero cross for relay closure by the relay-actuation delay 120 plus one-half of the relay contact-bounce duration 140. Consequently, as shown in FIG. 2, the relay contacts may continue bouncing for a period right after a zero cross possibly during high current conditions, thus suffering from similar behavior as shown in FIG. 1. Relay bouncing during this time period may cause the relay contacts to weld. Further, in operation, the duration of the relay bounce period may vary with each closure of the relay, thus the relay may actually become steadily closed at any time within the relay contact-bounce duration 140.

### SUMMARY

As disclosed herein, a load control device for controlling an amount of power delivered from an alternating current (AC) power source to an electrical load may include a relay operable to be coupled in series electrical connection between the AC power source and the electrical load. The relay may include one or more relay contacts. The load control device may include a zero-cross detector operable to detect zero crosses of the alternating current and to generate zero cross signals, and a controller operatively coupled to a control input of the relay and the zero-cross detector for rendering the relay conductive and non-conductive. The controller may determine a relay actuation adjustment such that the contact reliably completes bouncing just prior to a zero cross and may initiate an actuation of the relay based on the actuation adjustment and the zero cross signal.

For example, the relay actuation adjustment may be determined based on a relay-actuation delay and an average relay contact-bounce duration associated with the relay. The relay-actuation delay corresponds to a time difference between an initiation of actuation and the closure of the relay contact in response to the actuation. The average relay contact-bounce duration may correspond to the average time difference between an initial closure of the contact device and the contact resting in a closed state. The relay actuation adjustment may be determined based on the sum of the relay-actuation delay and one and one half of the average relay contact-bounce duration associated with the relay. The relay actuation adjustment may be adjusted periodically such that the time difference between the initial closure of the relay contact and the target zero cross is below a predetermined threshold.

The load control device may be operable in a plurality of states such as an initiate state, a search state, an adjust state and a hold state. In the initiate state, the controller may identify a wiring configuration based on the zero cross signal and the initial closure signal. When a reverse wiring configuration is identified, the controller may use the zero cross signal as the initial closure signal and use the initial closure signal as the zero cross signal. In the search state, the controller may determine a baseline actuation adjustment such that, when the controllably conductive device is actuated based on the baseline actuation adjustment, the initial closure signal is received within a time window from a subsequent zero cross. In the adjust state, the controller may determine the actuation adjustment by adjusting from the baseline actuation adjustment, such that the relay contact reliably completes bouncing just prior to a zero cross. In the hold state, the controller may control the actuation of the controllably conductive device based on the actuation adjustment and the zero cross signal and may not adjust the relay actuation adjustment for a predetermined number of switching cycles.

### BRIEF DESCRIPTION OF THE DRAWINGS

FIG. 1 depicts an AC voltage waveform as controlled by an example prior art relay switch control circuit.

FIG. 2 depicts an AC voltage waveform as controlled by an example prior art relay switch control circuit with bounce compensation.

FIG. 3 depicts an AC waveform as controlled by an example load control device having adaptive zero cross relay switching with improved bounce compensation.

FIG. 4 is a flow diagram illustrating an example method as disclosed herein for adaptively controlling a closure of a relay switch such that the relay contacts reliably complete bouncing just prior to a zero cross.

FIG. 5 is a schematic diagram illustrating an example load control device as disclosed herein.

FIG. 6 is a state diagram illustrating an example implementation of adaptively controlling a relay such that the relay contacts reliably complete bouncing just prior to a zero cross.

FIGS. 7 and 8 depict waveforms in an example load control device having adaptive zero cross relay switching with improved bounce compensation.

FIG. 9 depicts an AC waveform as controlled by an example load control device operable to detect potential errors when closing a relay prior to a positive half cycle.

FIG. 10 depicts an AC waveform as controlled by an example load control device operable to detect potential errors when closing a relay prior to a negative half cycle.

### DETAILED DESCRIPTION

FIG. 3 depicts an AC waveform in example load control device having adaptive zero cross relay switching with improved bounce compensation. Contact bouncing during high current conditions may shorten the operative life of a load control device. The load control device may control the relay actuation such that the relay contacts may reliably complete bouncing just prior to a zero cross. For example, the relay actuation time may be adjusted such that the relay contacts may complete or substantially complete bouncing close to but prior to a target zero cross. The load control device may use the average relay contact-bounce duration for determining the desirable relay contact actuation time. For example, in addition to relay actuation delay, the relay actuation time may be adjusted by one and one-half of the average relay contact-bounce duration.

As shown in FIG. 3, the load control device may actuate the relay at relay actuation time 330 such that relay contact bounce 340 may be completed prior to target zero cross 310B. In FIG. 3, waveform 300 depicts the waveform of the AC power source, where the portion in dashed line may represent the voltage of the AC power source, and the portion in solid line may represent the voltage across an electrical load. As shown, the AC waveform 300 may cross the neutral or zero line at voltage zero crosses such as the zero crosses 310A and 310B. The load control device may detect the zero crosses such as zero cross 310A and may target the relay contacts to close prior to a subsequent zero cross such as the target zero cross 310B.

The load control device may actuate the relay at the relay actuation time 330 prior to the target zero cross 310B for the relay closure. As shown, the relay actuation time 330 may lead the target zero cross 310B by a relay-actuation delay 320, the average relay contact-bounce duration 350 and one-half of the average relay contact-bounce duration 360. The relay-actuation delay 320 may correspond to the time interval between relay actuation time and when the relay contacts initially close in response to actuation.

In operation, the load control device may detect the zero cross 310A, determine and wait for a relay actuation adjustment 370, and actuate the relay at the relay actuation time 330. The relay actuation adjustment 370 may correspond to the difference between a full AC line cycle and the sum of the relay-actuation delay 320, the average relay contact-bounce duration 350 and one-half of the average relay contact-bounce duration 360. As a result, after the relay is actuated at the relay actuation time 330, the contacts of the relay may initially close at relay initial closure time 335. The relay contacts may bounce for a relay contact-bounce duration. Although the relay contact-bounce duration of a relay may vary with each relay closure, because the load control device adjusts the relay actuation time by one and one-half of the relay contact-bounce duration, the contacts may reliably complete bouncing prior to but close to a target zero cross. For example, the relay actuation adjustment 370 may be determined such that the relay contact completes bouncing just prior to a target zero cross with 95% confidence interval when initiating the actuation based on the relay actuation adjustment.

FIG. 4 is a flow diagram illustrating an example method as disclosed herein for adaptively controlling a closure of a relay switch such that the relay contacts reliably complete bouncing just prior to a zero cross. As shown, at 400, the method for adaptively controlling a relay switch may start. At 402, a relay-actuation delay may be determined. The relay actuation delay may correspond to the time difference between when the relay actuation starts and when the relay contacts are initially closed in response to the actuation. The determination is described herein, at least in relation to FIG. 7. The relay-actuation delay may be stored as a parameter value in memory. In operation, the relay-actuation delay may be retrieved from memory.

At 404, an average relay contact-bounce duration may be retrieved from memory. The average relay contact-bounce duration may correspond to the average amount of time the relay contacts may bounce during relay closure. For example, for certain relays, the average relay contact-bounce duration has been determined to be about 200 μs more or less. The average relay contact-bounce duration may be calculated based on the maximum relay contact-bounce duration observed through experimentation. For example, the average relay contact-bounce duration may be one half of the maximum relay contact-bounce duration. The average relay contact-bounce duration may be stored as a parameter value in memory. In operation, the average relay contact-bounce duration may be retrieved from memory. The average relay contact-bounce may be determined by the load control device during operation.

At 406, a relay actuation adjustment may be determined. The relay actuation adjustment may be indicative of the time interval between a detected zero cross and when the relay closure is initiated. The relay actuation adjustment may be determined based on the relay-actuation delay and the average relay contact-bounce duration. For example, the relay actuation adjustment may be equal to a full AC line cycle minus the sum of the relay-actuation delay and one and one-half of the average relay contact-bounce duration (e.g., 300 μs). For example, the relay actuation adjustment may be equal to a full AC line cycle minus the sum of the relay-actuation delay and one and one-fourth of the average relay contact-bounce duration (e.g., 250 μs). For example, the relay actuation adjustment may be equal to a half AC line cycle minus the sum of the relay-actuation delay and one and one-half of the average relay contact-bounce duration, or a half AC cycle minus the sum of the relay-actuation delay and one and one-fourth of the average relay contact-bounce duration. At 407, the relay actuation adjustment may be stored as a parameter value in memory.

At 408, a zero cross may be detected. For example, a voltage zero cross of the AC waveform may be detected using a voltage zero cross detector. For example, a current zero cross of the AC waveform may be detected using a current zero cross detector.

At 410, the relay actuation may be initiated based on the relay actuation adjustment and the detected zero cross. For example, upon detecting the zero cross, the relay actuation time may be determined based on the relay actuation adjustment value stored in memory and the time of the detected zero cross. The relay actuation time may correspond to the time following a detected zero cross by a time period corresponding to the relay actuation adjustment. In other words, the load control device may determine and wait for a time period that corresponds to the relay actuation adjustment before actuating the relay at the relay actuation time. At 420, the method may end.

FIG. 5 is a schematic diagram illustrating an example load control device as disclosed herein. The method described in FIG. 4 may be performed by one or more components illustrated in FIG. 5. The load control device 500 may include a controllably conductive device 504 coupled in series electrical connection between an AC power source 502 via a hot terminal H and an electrical load 518 via a switched hot SH terminal for control of the power delivered to the electrical load 518. The controllably conductive device 504 may include a relay or other switching device, or any suitable type of bidirectional semiconductor switch, such as, for example, a triac, a field-effect transistor (FET) in a rectifier bridge, or two FETs in anti-series connection. The controllably conductive device 504 may include contacts that may bounce upon closure. The controllably conductive device 504 may include a control input coupled to a drive circuit 508.

The load control device 500 may include a controller 520 for controlling the operation of the load control device 500. The controller 520 may include a microcontroller, a programmable logic device (PLD), a microprocessor, an application specific integrated circuit (ASIC), a field-programmable gate array (FPGA), or any suitable processing device or control circuit. The load control device 500 may include a zero-cross detector 510 for detecting the zero crosses of the input AC waveform from the AC power source 502. A zero cross may be the time at which the AC supply voltage transitions from positive to negative polarity, or from negative to positive polarity, at the beginning of each half-cycle. A zero cross may be the time at which the AC supply current transitions from positive to negative polarity, or from negative to positive polarity, at the beginning of each half-cycle. The controller 520 may receive the zero cross information from the zero-cross detector 510 and may provide the control inputs to the drive circuit 508 to render the controllably conductive device 504 conductive and non-conductive at predetermined times relative to the zero crosses of the AC waveform. For example, the zero-cross detector 510 may generate a zero cross signal to the controller 520 upon detecting a voltage zero cross. The zero-cross detector 510 may generate a zero cross signal to the controller 520 upon detecting a voltage zero cross when the AC power source 502 enters a negative half cycle and when the AC power source 502 enters a positive half cycle. The zero-cross detector 510 may generate a zero cross signal to the controller 520 upon detecting a voltage zero cross only when the AC power source 502 enters a negative half cycle. The zero-cross detector 510 may generate a zero cross signal to the controller 520 upon detecting a voltage zero cross only when the AC power source 502 enters a positive half cycle. The zero-cross detector 510 may generate a zero cross edge interrupt upon detecting the zero cross.

The controller 520 may also be coupled to a memory 512 for storage and/or retrieval of the average relay-bounce duration, the relay actuation adjustment, the duration of a half cycle, the duration of a full cycle, the relay-actuation delay, instructions/settings for controlling the electrical load 518, and/or the like. The memory 512 may be implemented as an external integrated circuit (IC) or as an internal circuit of the controller 520. A power supply 506 may generate a direct-current (DC) voltage VCC for powering the controller 520, the memory 512, and other low voltage circuitry of the load control device 500.

The load control device 500 may include an initial closure detector 516 for detecting an initial closure of the controllably conductive device 504. Upon detecting the initial closure of the controllably conductive device 504, the initial closure detector 516 may generate an initial closure signal to the controller 520. The initial closure detector 516 may generate an initial closure signal to the controller 520 when the relay is closed in a negative half cycle and when the relay is closed in a positive half cycle. The initial closure detector 516 may generate an initial closure signal to the controller 520 only when the relay is closed in a negative half cycle. The initial closure detector 516 may generate an initial closure signal to the controller 520 only when the relay is closed in a positive half cycle. The initial closure detector 516 may generate an initial closure edge interrupt on the initial closure signal upon detecting the initial closure of the controllably conductive device 504. The initial closure detector 516 may comprise similar circuitry as the zero-cross detector 510.

The controller 520 may receive an input signal 522 from an input circuit 524 (e.g., such as a user interface). Upon receiving an input signal 522 indicating the controllably conductive device is to be conductive, the controller 520 may initiate relay actuation such that the relay contacts complete or substantially complete bouncing just prior to a subsequent zero cross. For example, upon receiving the input signal 522, the controller 520 may wait for a signal from the zero-cross detector indicating a voltage zero cross has occurred. The controller 520 may determine a time, based on the timing of the zero cross, for providing a drive signal to the drive circuit 508 to actuate the controllably conductive device 504. The time for providing a drive signal to the drive circuit 508 may correspond to the relay actuation time 330 described herein with respect to FIG. 3.

FIG. 6 is a state diagram illustrating an example implementation of adaptively controlling a relay such that the relay contacts reliably complete bouncing just prior to a zero cross. At 600, the adaptive controlling of the relay may start. At 610, the load control device may operate in an initial state. In the initial state, the controller 520 may identify a wiring configuration based on the zero cross signal and the initial closure signal. The controller 520 may determine that the wiring configuration is standard wiring based on a determination that the zero cross signal generates interrupts when the relay is open. For example, the wiring configuration of the load control device 500 may be considered the standard wiring configuration when the hot terminal H is coupled to the AC power source 502 and the switched hot terminal SH is coupled to the electrical load 518. The wiring configuration of the load control device 500 may be the reverse wiring configuration when the switched hot terminal SH is coupled to the AC power source 502 and the hot terminal H is coupled to the electrical load 518. The controller 520 may determine that the wiring configuration may be a reverse wiring based on a determination that the initial closure signal generates interrupts when the relay is open. When reverse wiring is identified, the controller may use the zero cross signal as the initial closure signal and use the initial closure signal as the zero cross signal. In addition, during the initial state 610, the load control device may initially use a baseline relay actuation adjustment which may be a predetermined value. The baseline relay actuation adjustment may be used for adjusting the actuation adjustment in an adjust state described herein.

At 630, the load control device may operate in the adjust state. In the adjust state, the controller 520 may be operable to determine the relay actuation adjustment 370 by adjusting from the baseline relay actuation adjustment. The relay actuation adjustment 370 may be determined such that the relay contact may complete or substantially complete bouncing close to but prior to a target zero cross. The controller 520 may determine the relay actuation delay associated with the relay based on the time difference between the zero cross signal and the initial closure signal.

FIGS. 7 and 8 are waveform diagrams showing an example of adjusting the relay actuation time, for example, in the adjust state. In FIG. 7, waveform 1100 depicts the waveform of the AC power source, where the portion in dashed line may represent the voltage of the AC power source, and the portion in solid line may represent the voltage across an electrical load. As shown, the AC waveform 1100 may cross the neutral or zero line at voltage zero crosses such as the zero crosses 1110A and 1110B.

The controller 520 may initiate a turn on sequence and wait for a first zero cross edge interrupt 1120A. The zero-cross detector 510 may detect zero cross 1110A, and may generate first zero cross edge interrupt 1120A. The first zero cross edge interrupt 1120A may be received briefly after the actual zero cross 1110A, for example, after a hardware delay 1115.

Upon receiving the zero cross edge interrupt 1120A, the controller 520 may determine a relay actuation time 1135A. The relay actuation time 1135A may correspond to a time point following the zero cross edge interrupt 1120A by the baseline relay actuation adjustment 1125. For example, the controller 520 may start a timer that may stop or expire after running for the baseline relay actuation adjustment 1125 to trigger the relay actuation at the relay actuation time 1135A. When the timer expires, the controller 520 may generate a relay set signal to the drive circuit 508. The relay set signal may remain active for a relay actuation duration. For example, if the relay is a latching relay, the relay actuation duration may be the time between the relay actuation time 1135C and a relay release time 1135B. Alternatively, the relay set signal may remain active for the entire time that the relay is to be closed.

The controller 520 may receive a second zero cross edge interrupt 1120B. The second zero cross edge interrupt 1120B may be received briefly after the zero-cross detector 510 detects the actual zero cross 1110B, for example, after the hardware delay 1115. Upon actuation of the relay at the relay actuation time 1135A, the relay contact may initially close after the relay actuation delay or the relay close delay 1150. The initial closure detector 516 may detect an initial closure of the relay contacts and may generate an initial closure edge interrupt 1140A on the initial closure signal. The controller 520 may receive an initial closure edge interrupt 1140A on the initial closure signal when the relay contacts initially close (e.g., prior to any potential relay bounce not shown in FIG. 7.) The relay-actuation delay associated with the controllably conductive device 504, which may correspond to the time difference between when the relay actuation starts and when the relay contacts are initially closed in response to the actuation, may be determined based on the time difference between the relay actuation time 1135A and the initial closure edge interrupt 1140A. The controller 520 may calculate a switching differential 1155A that may correspond to the time difference between the initial closure edge interrupt 1140A and the zero cross edge interrupt 1120B.

The controller 520 may adjust the baseline relay actuation adjustment based on the switching differential 1155A and the hardware delay 1115. For example, the adjusted relay actuation adjustment may be equal to the baseline relay actuation adjustment modified by the difference between the switching differential 1155A and the hardware delay 1115 (e.g., adjusted relay actuation adjustment=baseline relay actuation adjustment−(switching differential−hardware delay)).

FIG. 8 illustrates how the relay closes at the zero cross when the adjusted relay actuation adjustment is used. As shown, the AC waveform 1100 may cross the neutral or zero line at voltage zero crosses such as the zero crosses 1110C and 1110D.

The controller 520 may initiate a turn on sequence and wait for a first zero cross edge interrupt 1120C. The zero-cross detector 510 may detect zero cross 1110C, and may generate first zero cross edge interrupt 1120C. The first zero cross edge interrupt 1120C may be received briefly after the actual zero cross 1110C. Upon receiving the zero cross edge interrupt 1120C, the controller 520 may determine an adjusted relay actuation time 1135C. The adjusted relay actuation time 1135C may correspond to the adjusted relay actuation adjustment 1160 after the zero cross edge interrupt 1120C. The adjusted relay actuation adjustment 1160 may be determined based on the previous switching differential (e.g., the switching differential 1155A shown in FIG. 7) and the hardware delay 1115. The adjusted relay actuation adjustment 1160 may be determined by altering the baseline relay actuation adjustment or the previous relay actuation adjustment by a predetermined amount or as a factor the switching differential (e.g., one-half of the switching differential). The adjusted relay actuation adjustment 1160 may be determined by incrementing or decrementing the baseline relay actuation adjustment or the previous relay actuation adjustment by a predetermined amount.

The controller 520 may start a timer that may stop or expire after running for the adjusted relay actuation adjustment 1160 to trigger relay actuation at an adjusted relay actuation time 1135C. When the timer expires, the controller 520 may generate a relay set signal to the drive circuit 508. The relay set signal may continue to be active from the relay actuation time until the relay release time 1135D. The controller 520 may receive a second zero cross edge interrupt 1120D. The second zero cross edge interrupt 1120D may be received briefly after the zero-cross detector 510 detecting the actual zero cross 1110D. Upon actuation of the relay at the adjusted relay actuation time 1135C, the relay contact may initially close after relay actuation delay or the relay close delay 1150. The initial closure detector 516 may detect an initial closure of the relay contacts and may generate an initial closure edge interrupt 1140B on the initial closure signal. The controller 520 may receive an initial closure edge interrupt 1140B on the initial closure signal when the relay contact initially closes. The controller 520 may calculate a new switching differential 1155B that may correspond to the time difference between the initial closure edge interrupt 1140B and the zero cross edge interrupt 1120D. The new switching differential 1155B may be indicative of the time difference between the initial closure of the relay contact and the target zero cross.

The controller 520 may compare the new switching differential 1155B to the hardware delay 1115 to determine whether to further adjust the relay actuation adjustment. The controller 520 may determine to further adjust the relay actuation adjustment when the new switching differential 1155B is not equal to or is outside of a predetermined range of the hardware delay 1115. This may indicate that when the relay is actuated based on the adjusted relay actuation time, the relay does not initially close at, or close to, the target zero cross such as zero cross 1110D. The controller 520 may determine to adopt a given value of the relay actuation adjustment when the resulting switching differential 1155B is equal to or within a predetermined range of the hardware delay 1115. This may indicate that when the relay is actuated based on the adjusted relay actuation time, the relay is initially closed at, or sufficiently close to, the target zero cross such as zero cross 1110D.

Upon determining a relay actuation adjustment that may allow the relay contact to initially close at a target zero cross, the controller 520 may offset the relay actuation adjustment by one and one half of the average relay contact-bounce duration.

The relay actuation delay or relay close delay 1150 may change throughout the life of a relay due to aging or deterioration or due to different temperature or voltage conditions. The relay actuation adjustment may be updated using the process described herein with respect to FIGS. 7 and 8 to compensate for such changes. The adjustment may be performed, for example, periodically or upon detection of an error in closure time.

Turning back to FIG. 6, upon determining a relay actuation adjustment that may allow the relay contact to complete or substantially complete bouncing just prior to a zero cross (e.g., at some point within the average relay contact-bounce duration 350 and the one-half of the average relay contact-bounce duration 360), the load control device may operate in a hold state 640. In the hold state, the controller 520 may be operable to control the actuation of the controllably conductive device based on the relay actuation adjustment and the zero cross signal generated by the zero-cross detector 510.

In the hold state 640, the controller 520 may not adjust the relay actuation adjustment 370 for a predetermined number of switching cycles. For example, the load control device may transition from the hold state to the adjust state every predetermined number of switching cycles such as a switching cycle hold count. At 650, the controller 520 may determine whether the switching cycle hold count has been reached. The switching cycle hold count may be 900, 1000, 1100 or the like. Based on a determination that the switching cycle hold count has been reached, the load control device may transition from the hold state to the adjust state. The relay set time may be adjusted by the switching differential prior to entering the adjust state. Based on a determination that the switching cycle hold count has not been reached, the load control device may continue to operate in the hold state.

In the hold state 640, the controller 520 may monitor the time difference between the initial closure of the relay and the target zero cross. The controller 520 may compare the time difference to a predetermined threshold and determine whether a readjustment of the value of the relay actuation adjustment may be needed. For example, if the time difference is below a predetermined threshold, the controller 520 may alter, such as increment, the switching cycle hold count by 1. Upon detecting the time difference exceeding the predetermined threshold, the controller 520 may alter the switching cycle hold count by a significantly larger number such as 100, 150, 200, or the like such that the controller may transition from the hold state 640 to the adjust state 630 before a predetermined number of switching cycles have actually occurred.

In the hold state, the controller 520 may compare the time difference between the initial closure of the relay and the target zero cross to a predetermined high error threshold. Upon detecting the time difference exceeding the high error threshold, the load control device may immediately transition to the adjust state.

The load control device 500 may close the controllably conductive device 504 in alternating half cycles. Closing the controllably conductive device in alternating half cycles may extend the operative life of the controllably conductive device. If the current flow always occurs in the same direction when closing a relay, material may transfer between the relay contacts over time. Alternating between switching when there is a positive and negative current flow may prevent or reduce such undesirable material transfer.

As described herein, the controller 520 may monitor the time difference between the initial closure of the relay contact and the target zero cross. This time difference may be measured differently when closing the relay just prior to a positive half-cycle and when closing the relay just prior to a negative half-cycle. In an embodiment, the time difference can only be measured in the negative half-cycle.

FIG. 9 depicts an AC waveform as controlled by an example load control device operable to detect potential errors when closing a relay prior to a positive half cycle. In FIG. 9, waveform 900 depicts the waveform of the AC power source, where the portion in dashed line may represent the voltage of the AC power source, and the portion in solid line may represent the voltage across an electrical load. As shown in FIG. 9, the target closure time 915 may be just prior to zero cross 905B. The zero-cross detector 510 may generate a zero cross signal to the controller 520 upon detecting zero cross 905A. The initial closure detector 516 may detect that the relay contact initially closes at 910. The controller may determine whether the detected initial closure 910 falls within an error window 920. The error window may include a preset window (e.g., 500 μs after the negative half-cycle zero cross 905A and 1 ms prior to the positive half cycle zero cross 905B). If the detected initial closure 910 falls within the error window 920, the switching cycle hold count may be altered such that the hold state may exit prior to the regular hold state period. The switching differential as described herein, for example, with respect to FIGS. 7 and 8, may be calculated based on the difference 930 between the detected zero cross 905A and the detected initial closure 910.

FIG. 10 depicts an AC waveform as controlled by an example load control device operable to detect potential errors when closing a relay prior to a negative half cycle. In FIG. 10, waveform 1000 depicts the waveform of the AC power source, the portion in dashed line may represent the voltage of the AC power source, and the portion in solid line may represent the voltage across an electrical load. As shown in FIG. 10, the target closure time 1040 may be just prior to zero cross 1005. The zero-cross detector 510 may generate a zero cross signal to the controller 520 upon detecting zero cross 1005. The initial closure detector 516 may detect that the relay contact initially closes at 1010. The controller may determine whether the detected initial closure 1010 falls within an error window 1020. The error window 1020 may include a preset window (e.g., 500 μs after the negative half-cycle zero cross 1005 and 1 ms prior to the positive half cycle). If the detected initial closure 1010 falls within the error window 1020, the switching cycle hold count may be altered such that the hold state may exit prior to the regular hold state period. The switching differential as described herein, for example, with respect to FIGS. 7 and 8, may be calculated based on the difference 1030 between the detected zero cross 1005 and the detected initial closure 1010.

If a relay closure is measured in an error window, the switching cycle hold count may be altered such that the hold state may exit prior to the regular hold state period. The switching cycle hold count may be altered by a different value based on whether the error in the closure is caused by an increase in the relay-actuation delay or by a decrease in the relay-actuation delay. For example, when the target closure is just before a positive half-cycle, a decrease in the relay-actuation delay can be measured. When the target closure is just before a negative half-cycle, an increase in relay-actuation delay can be measured. As a large decrease in the relay-actuation delay may signify an erroneous lock was achieved, for example, at a low relay voltage, the switching cycle hold count may be altered by a larger value if the error in closure time or relay actuation time is caused by a decrease in the relay-actuation delay than by an increase in the relay-actuation delay.

As shown in FIG. 9, the detected initial closure 910 falling within the error window 920 may be due to the relay-actuation delay being decreased by a delay decrease 950. When a relay-actuation delay decrease is detected, the controller 520 may alter the switching cycle hold count by a first predetermined value (e.g., 200). As shown in FIG. 10, the detected initial closure 1010 falling within the error window 1020 may be due to the relay-actuation delay being increased by an adjustment increase 1060. When a relay-actuation delay increase is detected, the controller 520 may alter the switching cycle hold count by a second predetermined value (e.g., 100). The relay set time may be adjusted by the error amount prior to entering the adjust state. The error amount may correspond to the difference 930 between the detected zero cross 905A and the detected initial closure 910, or the difference 1030 between the detected zero cross 1005 and the detected initial closure 1010.

1. A load control device for controlling an amount of power delivered from an alternating current (AC) power source to an electrical load, the load control device comprising:
a relay operable to be coupled in series electrical connection between the AC power source and the electrical load, the relay having a contact;
a zero-cross detector operable to detect zero crosses of the AC power source and to generate a zero cross signal; and
a controller operatively coupled to a control input of the relay and the zero-cross detector for rendering the relay conductive and non-conductive, and operable to:
determine a relay actuation adjustment based on a sum of a relay-actuation delay associated with the relay and one and one half of an average relay contact-bounce duration associated with the relay; and
initiate an actuation of the relay based on the relay actuation adjustment and the zero cross signal.

2. The load control device of claim 1, further comprising an initial closure detector operable to:
detect an initial closure of the relay, and
generate an initial closure signal upon detecting the initial closure of the relay.

3. The load control device of claim 2, wherein the controller is operable to receive the initial closure signal from the initial closure detector and determine the relay-actuation delay based on a time difference between a target zero cross and the initial closure of the relay.

4. The load control device of claim 1, wherein the controller is operable to adjust the relay actuation adjustment periodically.

5. The load control device of claim 1, wherein the controller is operable to adjust the relay actuation adjustment upon detecting an error.

6. The load control device of claim 1, wherein the average relay contact-bounce duration corresponds to an average time difference between an initial closure of the relay and the relay resting in a closed state.

7. The load control device of claim 1, wherein the relay-actuation delay corresponds to a time difference between an initiation of actuation and a first closure of the relay in response to the actuation.

8. The load control device of claim 1, wherein the controller is operable to determine the relay-actuation delay based on a time difference between a zero cross and an initial closure of the relay.

9. A load control device for controlling an amount of power delivered from an alternating current (AC) power source to an electrical load, the load control device comprising:
a relay operable to be coupled in series electrical connection between the AC power source and the electrical load, the relay having a contact;
a zero-cross detector operable to detect zero crosses of the AC power source and to generate a zero cross signal; and
a controller operatively coupled to a control input of the relay and the zero-cross detector for rendering the relay conductive and non-conductive, and operable to:
determine a relay actuation adjustment such that the contact reliably completes bouncing just prior to a zero cross; and
initiate an actuation of the relay based on the relay actuation adjustment and the zero cross signal.

10. The load control device of claim 9, wherein the controller is operable to determine the relay actuation adjustment based on a relay-actuation delay and an average relay contact-bounce duration associated with the relay.

11. The load control device of claim 9, wherein the controller is operable to determine the relay actuation adjustment based on a sum of a relay-actuation delay associated with the relay and one and one half of an average relay contact-bounce duration associated with the relay.

12. The load control device of claim 11, wherein the controller is operable to determine an actuation time that corresponds to a time point following a detected zero cross by a time period corresponding to the relay actuation adjustment, and to initiate the actuation of the relay at the actuation time.

13. The load control device of claim 9, wherein the controller is operable to close the relay just prior to a target zero cross before a positive half-cycle, and to close the relay just prior to a target zero cross before a negative half-cycle in alternate closures.

14. The load control device of claim 9, wherein the controller is operable to determine the relay actuation adjustment such that the contact reliably completes bouncing just prior to a target zero cross with a 95% confidence interval.

15. A method for controlling a controllably conductive device operable to deliver an alternating current power source to an electrical load, the method comprising:
determining a relay actuation adjustment such that the controllably conductive device reliably completes bouncing just prior to a target zero cross of the alternating current;
detecting a zero cross of the alternating current; and
initiating an actuation of the controllably conductive device based on the relay actuation adjustment and a timing of the detected zero cross.

16. The method of claim 15, further comprising:
adjusting the relay actuation adjustment every predetermined number of switching cycles.

17. The method of claim 15, wherein the relay actuation adjustment is determined based on a relay-actuation delay associated with the controllably conductive device and an average relay contact-bounce duration associated with the controllably conductive device.

18. The method of claim 15, wherein the relay actuation adjustment is determined based on a sum of a relay-actuation delay associated with the controllably conductive device and one and one half of an average relay contact-bounce duration associated with the controllably conductive device.

19. The method of claim 18, wherein the average relay contact-bounce duration corresponds to an average time difference between an initial closure of the controllably conductive device and the controllably conductive device resting in a closed state.

20. The method of claim 15, wherein the relay actuation adjustment is determined based on a sum of a relay-actuation delay associated with the controllably conductive device and approximately one and one half of an average relay contact-bounce duration associated with the controllably conductive device.

21. The method of claim 15, further comprising:
detecting an initial closure of the controllably conductive device; and
determining a relay-actuation delay based on the timing of the target zero cross and the timing of the detected initial closure of the controllably conductive device.

22. The method of claim 21, wherein the relay-actuation delay corresponds to a time difference between an initiation of actuation and a first closure of the controllably conductive device in response to the actuation.

23. The method of claim 15, further comprising:
determining an actuation time that corresponds to a time point following the detected zero cross by a time period corresponding to the relay actuation adjustment.

24. The method of claim 15, further comprising:
adjusting the relay actuation adjustment periodically.

25. The method of claim 15, further comprising:
adjusting the relay actuation adjustment upon detecting an error in closure time.

26. The method of claim 15, further comprising:
closing the controllably conductive device just prior to a first zero cross before a positive half-cycle; and
closing the controllably conductive device just prior to a second zero cross before a negative half-cycle.

27. The method of claim 15, further comprising:
adjusting the relay actuation adjustment periodically such that a time difference between an initial closure of the controllably conductive device and the target zero cross is below a predetermined threshold.

28. The method of claim 15, further comprising:
tracking a switching cycle count;
measuring a time difference between an initial closure of the controllably conductive device and the target zero cross;
altering the switching cycle count based on the measured time difference; and
adjusting the relay actuation adjustment when the switching cycle count reaches or exceeds a predetermined threshold.

29. The method of claim 28, wherein the switching cycle count is altered by a first number when the measured time difference is less than the predetermined threshold, and by a second number when the measured time difference equals or is greater than the predetermined threshold, wherein the first number is less than the second number.

30. The method of claim 28, wherein the switching cycle count is altered by a first number when the measured time difference is a result of an increase in a relay-actuation delay, and by a second number when is a result of an decrease in the relay-actuation delay, wherein the first number is less than the second number.
